(19) United States
(12) Patent Application Publication
(10) Pub. No.: US 2017/0070778 A1
(43) Pub. Date: Mar. 9, 2017

(54) Personal Secure Event Recording Device

(71) Applicant: Joshua Ryan Zerlan, Olathe, KS (US)

(72) Inventor: Joshua Ryan Zerlan, Olathe, KS (US)

(21) Appl. No.: 14/845,561

(22) Filed: Sep. 4, 2015

(51) Int. Cl. H04N 21/4408; G06F 21/60; H04N 21/2743; H04N 21/433; H04N 21/422; H04N 21/4223; H04N 21/437; H04N 5/913; H04N 21/61

(52) U.S. Cl. CPC H04N 21/4408; H04N 5/913; G06F 21/602; H04N 21/2743; H04N 21/6175; H04N 21/42203; H04N 21/4223; H04N 21/437; H04N 21/4334; H04N 2005/91364

(57) ABSTRACT

A device may passively record or transmit data characterizing the environment of a user and/or the physiological condition of the user. The device may encrypts and/or cryptographically sign data for storage and/or transmission. Cryptographically secured data may be transmitted from the device to at least a second computing device, either in real-time or after being stored. Encrypted data may be decrypted only if the private key associated with the user is provided. Cryptographic signature(s) may validate the data. A device may optionally operate in conjunction with a mobile communication device. Batteries to power the operation of the device may be used as part of a strap that may retains the device to the user.

### CROSS-REFERENCE TO RELATED APPLICATIONS

None.

### FIELD OF INVENTION

The present invention relates to systems and methods for securely recording events. More particularly, the present invention relates to wearable devices that cryptographically secure video, photographic, audio, location, and/or biometric records of events transpiring around the wearer.

### BACKGROUND AND DESCRIPTION OF THE RELATED ART

Numerous and diverse individuals would benefit from having a verifiable record of their activities and the activities and events around them. Police officers, young children, dementia patients, and even ordinary citizens may desire or even benefit from a convenient device to record their activities and interactions. While mobile devices such as smartphones and various wearable cameras may provide limited recording capabilities, these devices require affirmative activation of recording and often are invasive when worn or used. Further, files recorded by conventional video/photo/audio recording devices are subject to modification or tampering that may or may not be readily detectable, depending upon the sophistication of the hypothetical or actual individual seeking to modify the file(s). A further obstacle to widespread adoption of personal recording technology is privacy concerns should the records be obtained by a third party.

### SUMMARY OF THE INVENTION

The present invention cryptographically secures recordings of the environment, interactions, activities, and/or physiological traits of the user of a device in accordance with the present invention. Recordings may be cryptographically secured by signing some or all of the data and/or by encrypting the data in whole or in part. By cryptographically securing the recordings, concerns over data tampering that may occur in a judicial or quasi-judicial context are reduced or eliminated. For example, frames of video data recorded in accordance with the present invention may be signed using a checksum based in part upon the signatures applied to prior frames so that any tampering or modification of the video will be apparent. Cryptographically securing the recordings further eliminates or reduces privacy concerns, particularly when the data is encrypted, as only the individual possessing of the private key required to access the encrypted data may access the recordings. Systems and methods in accordance with the present invention may cryptographically sign data, may encrypt data, and/or may both cryptographically sign and encrypt data. Further, different types of data may be cryptographically secured in different fashions.

Systems and methods in accordance with the present invention may be used in a wide range of scenarios. In some scenarios a device in accordance with the present invention may take different forms. One example of a device in accordance with the present invention which is described herein can be worn on a user's wrist and resembles a wristwatch in size and shape. However, devices in accordance with the present invention may take a variety of forms. Some forms of devices in accordance with the present invention may be particularly suited to specific applications. For example, a device in accordance with the present invention for use by a police officer may be advantageously incorporated into a vest worn by the officer. By way of further example, a device in accordance with the present invention for use by a fire fighter may be advantageously incorporated into a helmet worn by the fire fighter. By way of yet a further example, a device in accordance with the present invention for use by a security guard may be advantageously incorporated into a flashlight or weapon carried by the guard. In an example where a device in accordance with the present invention is to be used by a dementia patient or child or other individuals, a device in accordance with the present invention may be advantageously worn as an anklet. In an example where a device in accordance with the present invention is to be used by a child, such a device may take the form of a pin or clip that may be affixed to the child's shirt. In some examples, a device in accordance with the present invention may be worn as a necklace. A variety of configurations of devices in accordance with the present invention may be implemented. The present invention is not limited to these exemplary configurations, and the exemplary configurations are not limited to the exemplary uses described herein.

A device in accordance with the present invention may be integrated into other devices, garments, tools, equipment, and/or vehicle. For example, a device in accordance with the present invention may be incorporated into headwear such as a hat or helmet, a garment such as a vest, a belt, an anklet, a watch, a necklace, a backpack, etc. In addition to being directly worn by a user, devices in accordance with the present invention may be affixed to a garment or integrated into a garment or gear worn or carried by a user and/or a vehicle, tool, and/or equipment used by a user. For example, a device in accordance with the present invention may be permanently or temporarily used in conjunction with a vehicle such as an automobile. A device in accordance with the present invention may provide a body that houses some or all of a lens, camera, microphone, digital storage, digital memory, communication interfaces, computer processor(s), and/or other electronics. One or more battery may be provided within the body of the device, may be integrated into a strap that secures the device to the user, and/or may be provided within a pack carried by the user (or the user's equipment, such as a car) and electrically connected to the device. While in some examples all electrical components other than one or more battery and/or one or more antenna are contained within the body of a device, other electrical components may be integrated into the strap that retains the device on the body of the wearer and/or external to the device but operably connected to the device.

By encrypting and/or signing recordings and requiring a private key associated with the user to decrypt the recording, systems and methods in accordance with the present invention may protect the privacy of both user(s) of the device(s) and individuals interacting with user(s) of the device(s). In some instances, the private key associated with the user may not be set by or limited to the individual using a device in accordance with the present invention. For example, in examples such as when a child, dementia patient, or other individual in some manner of custodial care is a user, the private key may be appropriately created and/or retained by a party with custodial responsibility for the user. In instances, such as when a user is a police officer or other public servant (or an employee of a private entity), a private key associated with the user may be additionally or exclusively available to the user's supervisor or other person in a position of authority. Of course, in many instances a user may set his or her own private key and then may choose to provide that private key to one or more other person within his or her discretion.

A device in accordance with the present invention may communicate with other devices using any protocol and/or any physical or wireless medium. Physical ports may be provided to mechanically and electrically connect the device to an external computer or other device to perform operations such as transferring data from the device. Data may alternatively/additionally be transferred wirelessly using any communication protocol, such as any 802.11 protocol, CDMA, GSM, Bluetooth, 3G, LTE, WiMax, ZigBee, near field communications, etc.

In some examples, devices in accordance with the present invention may provide wireless communication to transfer data of recordings to a remote location while and/or after the recordings are made. Such a transfer may occur continuously or when a user activates such a capability by engaging a user engageable input provided on the device. For example, a “panic button” may be provided that, when engaged, initiates a transfer of recordings to a remote location using a wireless communication protocol. Such a transfer may be the recordings being made by the personal recording device at that time, but may additionally/alternatively include a transfer of a predetermined or preselected amount of time prior to the engagement of the transfer (i.e., the prior five minutes, the prior ten minutes, etc.). In order to facilitate the transmission of such data in a rapid fashion with potentially limited data connectivity, data may be transferred in chunks that maximize the probative value of the data being transmitted. For example, initially a subset of video frames (such as every fifth frame, tenth frame, fiftieth frame, etc.) with the intervening video frames subsequently transmitted as possible and/or desired.

In some examples, systems in accordance with the present invention may use location services operating on the device itself and/or on another mobile computing device to obtain and record location information. One example of locations services that may be used in accordance with the present invention is a global positioning system (GPS) unit that uses satellite signals to measure the physical location of the unit. Other types of location services, such as use the location of wireless routers and/or cellular data towers to at least approximate the location of a device, may additionally/alternatively be used in accordance with the present invention. Location information may be cryptographically secured on a device in accordance with the present invention and/or transmitted at the initiation of a user to a remote location in conjunction with other recorded data.

A device in accordance with the present invention may operate independent of other devices when in use, but may additionally/alternatively be paired or otherwise operably connected with a mobile computing device during use or other piece of equipment, tool, and/or vehicle. In some examples, a mobile computing device (such as a smart phone) may provide an internet connection and/or location services for use by a device in accordance with the present invention. In some examples, a mobile computing device may be used to retain some or all of the cryptographically secured recordings made by a device in accordance with the present invention.

### BRIEF DESCRIPTION OF THE SEVERAL VIEWS OF THE DRAWINGS

Examples of systems and methods in accordance with the present invention are described in conjunction with the attached drawings, wherein:

FIG. 1 schematically illustrates an example device in accordance with the present invention;

FIG. 2 schematically illustrates a further example device in accordance with the present invention;

FIG. 3 schematically illustrates yet a further example of a device in accordance with the present invention;

FIGS. 4A and 4B illustrate planar views of opposing sides of an example of a device in accordance with the present invention;

FIG. 5 illustrates an example of a device in accordance with the present invention in use;

FIG. 6 illustrates an example of a method in accordance with the present invention;

FIG. 7 illustrates a further example of a method in accordance with the present invention;

FIG. 8 illustrates an example of a system in accordance with the present invention;

FIG. 9 illustrates data blocks that may be cryptographically secured in accordance with the present invention; and

FIG. 10 illustrates a method for cryptographically signing blocks of data in accordance with the present invention.

### DETAILED DESCRIPTION

The present invention provides systems and methods for recording the environment and/or biometrics of a user. Recordings may be cryptographically by encrypting and/or cryptographically signing the data recorded. Cryptographically securing the recorded data may protect privacy of the individual(s) in the recordings and may establish the authenticity of the recordings at a later time, if need be. Systems and methods in accordance with the present invention may securely record video, audio, still photos, location data, biometric data, and/or any other type of data.

Devices and systems in accordance with the present invention may perform methods in accordance with the present invention by providing at least one computer processor that functions under the control of an operating system maintained in a non-transitory form in a nonvolatile form of machine-readable media such as random access memory (RAM). At least one sensor may receive at least one input from the user and/or the user's environment. At least one processor may cryptographically secure the data received by the at least one input. Examples of cryptographically securing data are encrypting at least some of the data and/or cryptographically signing at least some of the data. A user of a device in accordance with the present invention may optionally select whether to cryptographically secure data by signing, encrypting, or both encrypting and signing the data. Cryptographically secured data may be stored within a device or system in accordance with the present invention and/or transmitted to one or more other devices. Cryptographically secured data may be transferred to another device without compromising the cryptographic security of the data. Several examples of ways in which data may be transferred from a device in accordance with the present invention to another computing device are described in examples herein, but other types of transfers may also be used. Encrypted data, whether retained locally or transmitted to another computing device, may require a private key associated with the user to be decrypted. Cryptographic signatures may use a blockchain technique to sign blocks of data (such as, but not limited to, video frames) with a checksum that incorporates information obtained from a prior block of data in order to render tampering with the data cryptographically obvious. One or both of encryption and cryptographic signature(s) may be used to cryptographically secure data in accordance with the present invention.

Data received from inputs in accordance with the present invention may comprise one or more of a wide range of types of data, such as image data (still images and/or video), audio data, location data (such as, but not limited to, global positioning data), accelerometer data, blood pressure data, heart rate data, blood oxygen data (VO2), blood glucose data, skin galvanic data, etc. Data received may be processed for digital storage or transmission using any type of processor, such as a specialized digital signal processor for audio data and/or video data or a general purpose processor. Data may be cryptographically secured using the same processor that processed data to a digital format, but a different processor (that may be devoted to cryptographic processes, but need not be) may operate to cryptographically secure the data. Data may be stored and/or transmitted in any format, data may be stored in a different format than used to transmit the data, and different types of data may be stored and/or transmitted in different formats.

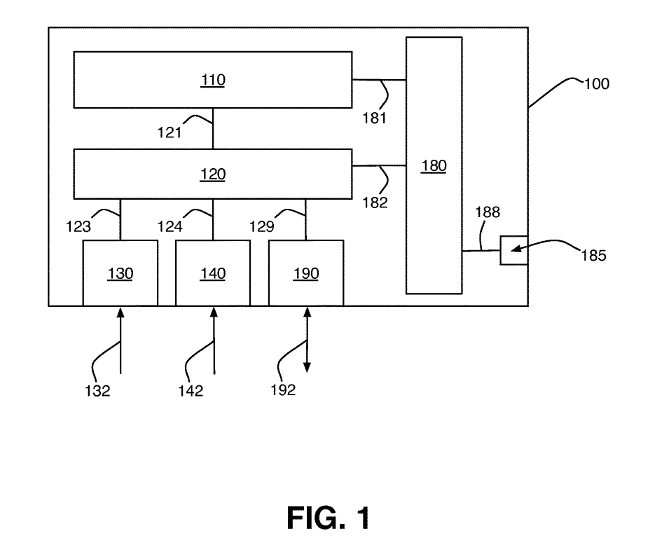

Referring to FIG. 1, the example of a device 100 in accordance with the present invention is illustrated. A device such as illustrated schematically in FIG. 1 may be wearable by a user, affixable to a user's clothing, and/or affixable to a user's equipment. Device 100 may comprise a housing formed of plastic, metal, nylon, or any other resilient material or combination of materials to contain the components used to record a user's environment and/or biometrics and encrypt and/or cryptographically sign of those recordings. Data of those recordings may be retained and/or transmitted in any format, such as but not limited to any file format. Device 100 may provide at least one digital storage medium 110.

At least one processor 120 may engage 121 with digital storage medium 110 in order to access and/or save data on digital storage medium 110. Processor 120 may be used to cryptographically secure (by encrypting and/or cryptographically signing) data recorded using various inputs. Processor 120 may comprise one or more processors executing computer-readable instructions in accordance with the present invention. Any type of processor(s) may be used in accordance with the present invention. In some examples, a processor 120 may be a general purpose processor that performs cryptographic functions, digital signal processing of received inputs, communicate with other computing devices, and/or generally controls the various operations of device 100. In other examples, a processor may comprise multiple processors used for different tasks, such that processor 120 comprises discrete specialized processors devoted to particular tasks such as signal processing and cryptography. For example, a processor may use a system-on-chip encryption component. However processor 120 is configured, processor 120 encrypts and/or cryptographically signs files with a public key such that decrypting the file(s) requires a private key associated with a user.

Device 100 may receive data from one or more of a variety of inputs. For example, a camera 130 may receive visual inputs 132 using a lens that focuses images on a CCD. Camera 130 may use a lens that receives inputs over any range of view, such as wide angle images/video of 180° or 360°. In some instances, wide angle images/video made using camera 130 may benefit from or require specialized viewers to display the video or still images in a format that may be understood by a human viewer. Camera 130 may interface 123 with processor 120 to record image and/or video data on digital storage medium 110 based on the input 132 received. Similarly, a microphone 140 may receive audio inputs 132. Microphone 130 may be connected 124 to processor 120 to enable audio data based on input 142 to be stored in digital storage medium 110. Processor 120 may encrypt and/or cryptographically sign the data received from camera 130, microphone 140, and/or other inputs (such as physiological sensors) to be retained in storage medium 110. A variety of other types of inputs may be received instead of or in addition to video and audio inputs. For example, any type of biometric data may be collected and stored in a cryptographically secured fashion, as most other data describing the location and/or ambient conditions of the device 100.

A power source 180 may be used to power the operations of the various components of device 100. As shown in the example of FIG. 1, power source 180 may be operably connected 181 to digital storage medium 110 and may be operably connected 182 to processor 120 and/or any other components requiring electrical power. In some examples power source 180 may comprise a battery that receives 188 an electrical charge via a power input 185 to permit, for example, charging from an electrical outlet or other electrical power source. In some examples, instead of or in addition to a battery, a power source 180 may comprise a fuel cell that produces electricity from a hydrogen source. If a fuel cell is used as a power source 180 in accordance with the present invention, a sensor may detect the temperature of the device 100 (which may comprise an input recorded and cryptographically secured in accordance with the present invention) and may eject and/or disengage a hydrogen supply and/or the entire device from the body of the user if the measured temperature exceeds a safe operating threshold. In other examples, a device in accordance with the present invention may power components via a connection to another electrical power supply, such as an electrical outlet from a structure or vehicle, a solar cell, and/or any type of electrical power generation device or system.

An input/output port 190 may also connect 129 to processor 120. Port 190 may be used to interface 192 with a second computing device to enable processor 120 to transfer secure files from storage medium 110 to the second computing device. Port 190 may additionally/alternatively be used to apply software and/or firmware updates to device 100 and its components. Port 190 may also be enable a user to interface with processor 120 to configure the public key used to encrypt and/or sign data/files stored on digital medium 110 and/or his or her private key used to de-encrypt secure files. In some examples, a single port, such as a port meeting one of the Universal Serial Bus (USB) standards may be used as both input/output port 190 and as a charging port 185 for any battery used.

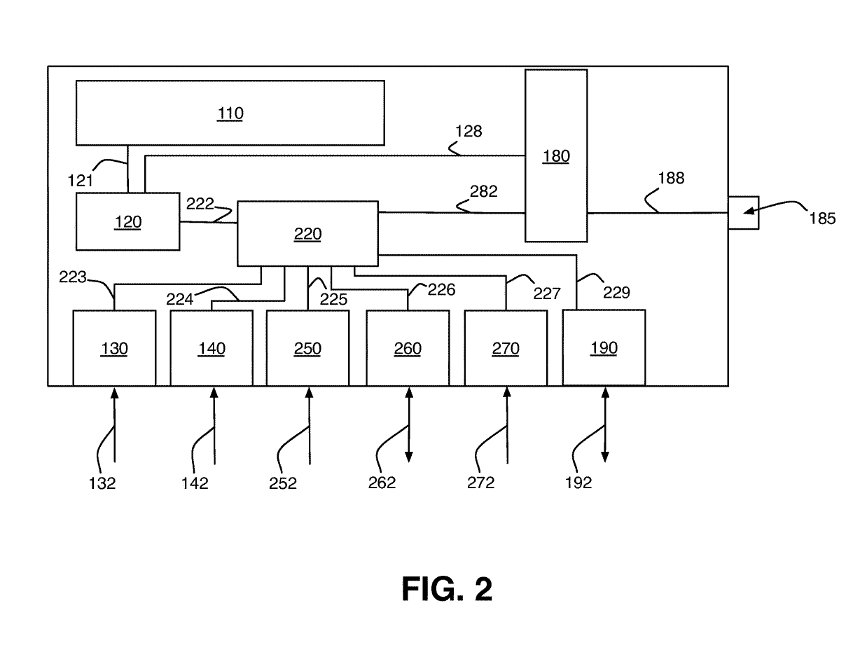

Referring now to FIG. 2, a further example of a device 200 in accordance with the present invention is illustrated. In the example illustrated in FIG. 2, device 200 may provide both an encryption component 120 capable of encrypting media files and a second processor 220 that performs general tasks not requiring encryption. As with the example of FIG. 1 described above, both encryption component 120 and processor 220 may comprise one or more processors performing functions as described herein. Encryption component 120 may comprise, for example, one or more system-on-chip encryption (SoC) system that encrypts and/or cryptographically signs data using a public key such that a private key associated with the user of device 200 is required to decrypt the file/data. The use of a SoC system dedicated to encryption purposes may enable efficient encryption and/or signing of data in real-time as the data is received by device 200. Second processor 220 may be one or more of any type of computer processor. In many examples, second processor 220 may comprise a plurality of processors performing tasks related to communicating between device 200 and other devices, digitizing and/or otherwise processing inputs received by sensors associated with device 200, communicating with other computing devices, operating the various components of device, and/or other tasks. A connection 222 between encryption processor 120 in general processor 220 may be used to hand off computing tasks requiring encryption from general processor 220 to encryption processor 120, such as transferring a digitizing signal containing received data from general processor 220 to encryption component 120.

As shown in the example of FIG. 2, in addition to a camera 130 to receive visual input 132 and/or a microphone 140 to receive audio input 142, example device 200 may also provide a location services unit 250 to receive location information 252. Location information 252 may require additional processing, such as triangulation performed by processor 220, to record location information in digital storage medium 110. Location services 250 may comprise, for example, global positioning system unit, but may use any type of location services system and/or software that uses known location information, such as may be available from satellites, cellular data towers, wireless routers, and the like, to determine a precise or general location for device 200.

While the example illustrated in FIG. 2 provides a location services component 250 and the example illustrated in FIG. 1 does not provide a location services component, the example device 100 illustrated in FIG. 1 may provide a location services component as well.

Device 200 may further provide at least one biometric sensor 270 that measure 272 data describing the physiological function of a user and provide measured biometric data to processor 220 via connection 227. For example, one or more biometric sensor may measure a user's heart rate, blood pressure, blood oxygen data (VO2), blood glucose, skin galvanic properties, etc. Further, one or more biometric sensor 270 may comprise one or more accelerometers that measure the movement of a user wearing device 200, although in some examples in accordance with the present invention one or more accelerometer may be used as a sensor in a device that is not worn by the user and, therefore, such movement data would describe the movement of the equipment, tool, or other item on which a device in accordance with the present invention is mounted on and/or integrated with.

Still referring to the example of FIG. 2, a secondary computing device interface 260 may exchange communications 262 with a secondary mobile computing device, such as a smartphone, tablet computer, laptop computer, etc. Communications 262 exchanged by secondary computing device interface 260 may transfer cryptographically secured data to a secondary computing device and/or may receive information from a secondary computing device to be cryptographically secured. In some examples in accordance with the present invention a secondary computing device may be used to configure the operation of device 200. Secondary computing device interface 260 may permit device 200 to access services (such as GPS services, storage services, and/or Internet access) using a secondary computing device. One example of a secondary computing device that may be accessed via secondary communication device interface 260 is a mobile communication device, such as a smart phone or tablet, but secondary computing device may be any kind of device, such as a laptop or desktop computer or even computing devices embedded in other devices such as automobiles or appliances. Examples of communication protocols that may be used to exchange communications 262 between device 200 and a secondary computing device using interface 260 are Bluetooth, ZigBee, and/or an 802.11 protocol, as well as USB or other types of physical links or protocols.

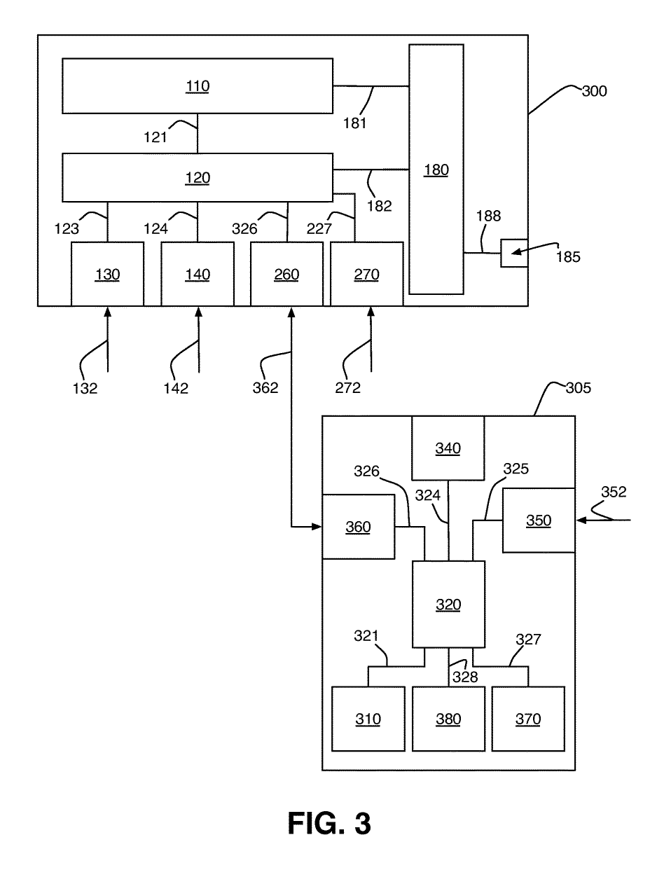

Referring now to FIG. 3, a further example of a device 300 in accordance with the present invention is illustrated. In the example of FIG. 3, a secondary computing device interface 260 communicates 362 with a mobile communication device 305, which may comprise a smart phone, tablet, or other type of device. Mobile communication device 305 possesses at least one processor 320 and at least one digital storage medium 310 operably connected 321 to enable mobile communication device 305 to perform in accordance with the present invention in conjunction with device 300. Communications 362 may be exchanged via Bluetooth, ZigBee, an 802.11 protocol, USB, or any other physical or wireless communication media and/or protocol. By exchanging communications 362 with mobile communication device 305, device 300 may utilize certain capabilities typically possessed by a mobile communication device in order to better operate in accordance with the present invention. For example, a mobile communication device 305 (such as, for example, a smart phone) may possess a GPS unit 350 that receives satellite signals 352 for use in determining the location of the mobile communication device 305 and, therefore, device 300. Further, mobile communication device 305 may provide a communication antenna 340 connected to processor 320. Antenna 340 may be used to exchange Wi-Fi signals, cellular data signals, etc. to access the Internet or other communication network. Antenna 340 may comprise one or a plurality of antennas operating at different wave lengths/frequencies to receive and transmit wireless signals at various radio frequencies as provided by any wireless communications protocol. For example, one or more antenna 340 may exchange data communications using Wi-Fi, any 802.11 protocol, LTE, WiMAX, etc.

Mobile communication device 305 may further provide an output mechanism 380 and an input mechanism 370. Output mechanism 380 may comprise one or more of a screen display and/or audio output via a speaker or a headset. By utilizing energy consuming output devices such as a display screen provided by mobile communication device 305 rather than incorporating a screen in device 300, the life of a battery used as power supply 180 provided in device 300 may be extended. In a similar fashion, input 370 provided by mobile communication device 305 may comprise, for example, a touch sensitive screen, buttons, and/or voice processing capabilities, which may be utilized by device 300 to better preserve battery 180 of device 300 and to simplify configuration of the operation of device 300. Further, device 300 may be easier to use for a typical individual by pairing device 300 with the more accessible and familiar output mechanism 380 and input mechanism 370 of a mobile communication device 305.

A device in accordance with the present invention may be powered by any type of battery or other electrical power source. In some examples, a device in accordance with the present invention may have one or more lithium polymer battery, thin film rechargeable lithium ion battery, and/or fuel cell. A thin film lithium ion battery replaces the liquid electrolyte material used in many other types of batteries with a solid-state electrolyte that may be shaped in ways that many other batteries cannot. Accordingly, a plurality of thin film lithium ion batteries may be formed to permit a device in accordance with the present invention to be powered by those batteries without the batteries encumbering the device. Additionally/alternatively, lithium polymer batteries may be formed in a variety of shapes retained within casings. In some examples, thin film lithium ion batteries and/or lithium polymer batteries may be incorporated into a device in accordance with the present invention as part of a mechanism to allow the device to be worn by a user. A device in accordance with the present invention may provide a housing that can be worn by the user, potentially in an orientation that permits one or more biometric sensor to contact the skin of the user, with some or all of the mechanism securing the device to the user containing one or more batter or fuel cell. In this fashion, a device in accordance with the present invention may be secured to the wrist, arm, leg, ankle, head, neck, waist, and/or other portions of a users anatomy. In some examples, a device in accordance with the present invention may provide a housing resembling a wrist watch in size and shape, and that housing may enclose an encryption component, digital storage media, processor(s), communication interface(s), second computing device interface(s), camera(s), microphone(s), and/or biometric sensor(s), with a plurality of thin film lithium ion batteries and/or lithium polymer batteries formed to be integral with one or more links in a bracelet to retain the housing to the user's wrist.

A variety of encryption techniques may be used to encrypt and cryptographically sign files in accordance with the present invention. One example of an encryption technique that may be used in accordance with the present invention is Advanced Encryption Standard (AES). AES uses block cyphers and secret keys of varying lengths (128-, 192, or 256-bits) that are required to encrypt and to decrypt a file encrypted using AES. Accordingly, in the example of a device in accordance with the present invention using AES, a user would use a public key (whether pre-existing or created by the user) to encrypt data/files and would create a secret key (the private key in some examples described herein) for use in decrypting data or files containing recorded video, audio, and/or location information for storage and/or transmission and also for use in decrypting the files. Without the secret key used to encrypt the file(s), the file(s) cannot be decrypted.

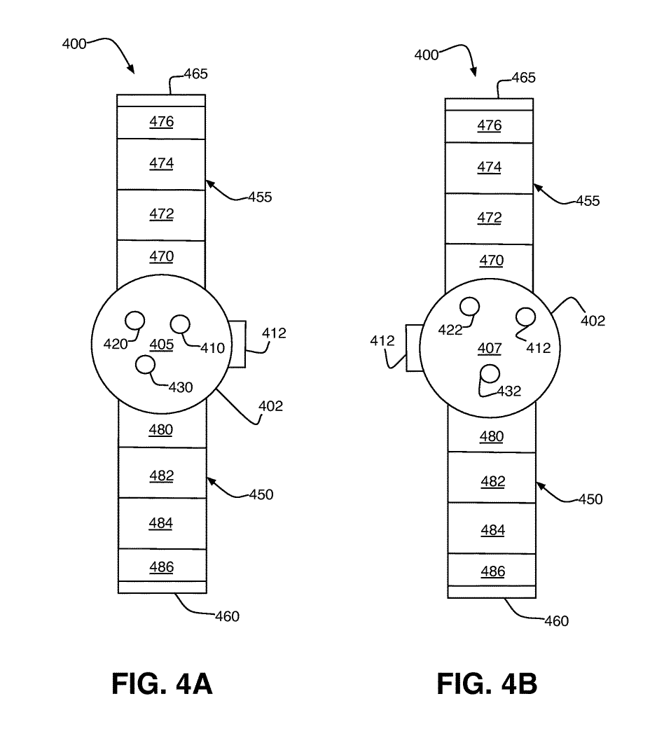

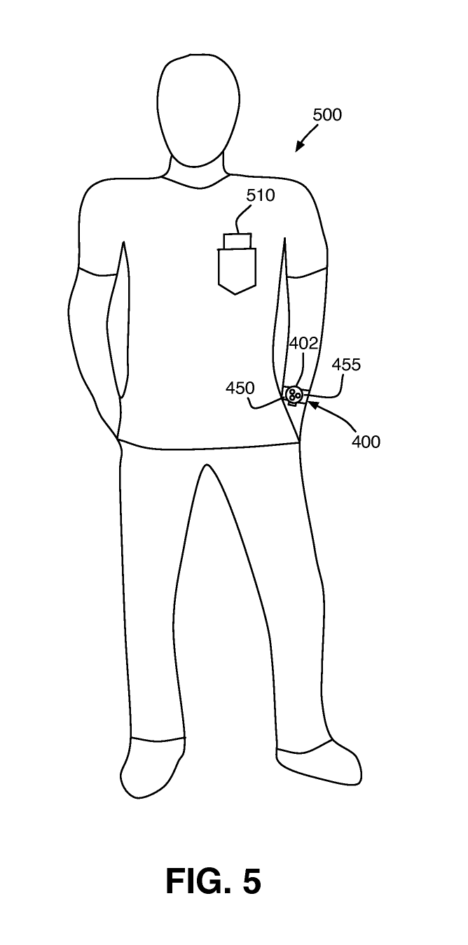

Referring now to FIGS. 4A and 4B and FIG. 5, an example of a device in accordance with the present invention is shown. The example of FIGS. 4A and 4B shows a device with a form and size resembling a wristwatch, but devices in accordance with the present invention may take on different forms, sizes, and shapes than as shown in the present example and may be worn at locations of a user's anatomy other than a wrist or not worn at all. For example, a device in accordance with the present invention may occupy a larger portion of a user's wrist and/or forearm than shown. By way of further example, a device in accordance with the present invention may be worn in a variety of ways by a user. In some examples, a device in accordance with the present invention may be integrated (temporarily or permanently) into garments and/or gear worn or carried by a user. For example, a device in accordance with the present invention may be worn as part of a hat, cap or helmet; as part of a vest, jacket, or coat; as part of a shirt; as part of pants, shorts or skirt; as part of a dress; as part of protective gear such as a clean suit or body armor; as part of a shoe or boot; as part of a handbag, attaché, briefcase or purse; as part of glasses; and/or as part of any other type of gear used by an individual.

Referring to FIG. 4A, a device 400 may provide a housing 402 that contains some or all of the electronic components of the device 400. An outward face 405 of housing 402 may provide one or more opening (which may be protected from moisture or other environmental hazards) sufficient for the operation of a camera 410, a microphone 420, and/or a port 430 to interface with a secondary computing device. The configuration of camera 410, microphone 420, and port 430 on outward face 405 depicted in the example of FIG. 4A is exemplary only, as different arrangements (such as locating one or more on the outer perimeter or side of housing 402) may be used for those or other components of device 400.

One or more processor, such as at least one encryption component, at least one secondary processor, one or more digital storage media, wireless communication interface(s), one or more battery or other power source, and/or location services components may be contained within housing 402 or elsewhere in device 400. Any other components, electrical or mechanical, that may be desired may likewise be contained with housing 402, on housing 402, and/or elsewhere in device 400. Housing 400 may have a size and shape corresponding to that of a wristwatch, but may take other sizes and/or shapes. Housing 400 may be formed from any metal, plastic, or other material.

Still referring to FIG. 4A, a first band portion 450 and a second band portion 455 may be used to retain housing 400 and any electronic components contained in housing to the wrist (or elsewhere on the body) of a user. A first clasp portion 460 and a second clasp portion 465 may be used to secure the first band portion 450 and second band portion 455 together to secure the device to the wrist of a user. In some examples, a band or band portion 450, 455 may be formed without links. In the example of FIG. 4, one or more links 480, 482, 484, 486 of first band portion 450 and/or one or more links 470, 472, 474, 476 of second band portion may contain or entirely comprise a battery used to power the electronic components within housing 400. Any number of links (including a single link that comprises a bracelet or other strap to secure the device to the user) may be used in accordance with the present invention. While one or more battery may be provided within housing 400, additionally/alternatively providing one or more battery within one or more band portion 450, 455 may greatly extend the operation of a device in accordance with the present invention. For example, one or more thin film lithium ion battery and/or one or more lithium polymer battery may be provided within housing 400, within links 480, 482, 484, 486 of first band portion, and/or within links 470, 472, 474, 476 of second band portion 455. If one or more battery is provided within one or more links of first band portion 450 and/or second band portion 455, one or more electrical connections may be provided between one or more link and electrical components with housing 402 powered by the battery or batteries so provided.

Other components of a device 400 may likewise be incorporated into a first band portion 450, a second band portion 455, and/or a link(s) of a band portion. For example, inputs such as camera(s), microphone(s), and/or biometric sensor(s) may be incorporated into a band, band portion, and/or any link. In some examples, one or more antenna may be provided in or as part of a band, band portion, and/or any link(s) in order to increase the size of the antenna beyond what might be possible were the antenna contained within housing 402. In such an example such an antenna would be electrically connected to the component(s) using the antenna, and such component could be within housing 402.

Still referring to the example of FIG. 4A, at least one button 412 or other input component may be accessible to a user. While the at least one button 412 may be used in a variety of ways to permit a user to interact with a device 400 in accordance with the present invention, in some examples a button 412 may be used to initiate the transfer of data (such as previously stored cryptographically secured data and/or data from the user's environment as the recording occurs) to a secondary or remote computing device. For example, button 412 may function as a “panic button” that streams data from the camera 410, microphone 420, and/or location services components or other inputs to a previously selected remote computing device over the Internet or other data network. In some examples in accordance with the present invention, a predetermined amount and/or portion of cryptographically secured data recorded prior to the engagement of button 412 may also be transmitted to the remote computing device, such as five minutes worth of data, ten minutes worth of data, an hour of data, the last available location data, etc. In such an example, the remote computing device may have previously been provided with a private key associated with the user to permit encrypted data received at the remote computing device to be decrypted.

FIG. 4B illustrates a skinward face 407 of device 400. Skinward face 407 may optionally contact the skin of a user to permit at least one biometric sensor to measure biometric data describing the physiological condition of the user. While not all biometric sensors require contact with the skin of a user, some types of biometric data may require skin contact in order to me measured. While the example of FIG. 4B shows a first biometric sensor 412 (that may comprise, for example, a heart rate sensor), a second biometric sensor 422 (that may comprise a galvanic sensor, for examples), and a third biometric sensor 732 (that may comprise, for example, an accelerometer), more, fewer, and/or different biometric sensors may be used with a device in accordance with the present invention. A sensor (whether a biometric sensor or not) that does not require contact with the skin of a user and that does not require access to a user's environment (such as an accelerometer) may be located within housing 402 of device 400 rather than on the outward face 405 or the skinward face 407 or the edge/perimeter of the device 400 housing 402 depicted in the examples of FIGS. 4A and 4B as the location of button 412. In some examples, device 400 may receive biometric data from biometric sensors provided within a band portion 450, 455 and/or in other devices in communication with device 400, such as various biometric measuring devices.

FIG. 5 illustrates an example of a device 400 in accordance with the present invention while worn by a user 500. Housing 402 is retained on the wrist of the user 500 by the first strap portion 450 and the second strap portion 455 so that at least camera 410 and microphone 420 may receive data from the environment around user 500. In the example of FIG. 5, one or more biometric sensor 212, 422, and/or 432 may contact the skin of user 500 to measure biometric data while device 400 is worn.

In the example of FIG. 5, a mobile communication device 510 may be paired with the device in accordance with the present invention (for example, using a Bluetooth or other protocol) to permit the device to store secure files on mobile communication device 510, to utilize location services on mobile device 510, and/or to use mobile device 510 to wirelessly access the Internet or other data communication network wirelessly. In some examples, engaging button 412 may cause mobile communication device 510 to be used to transmit recorded information to a remote computing device.

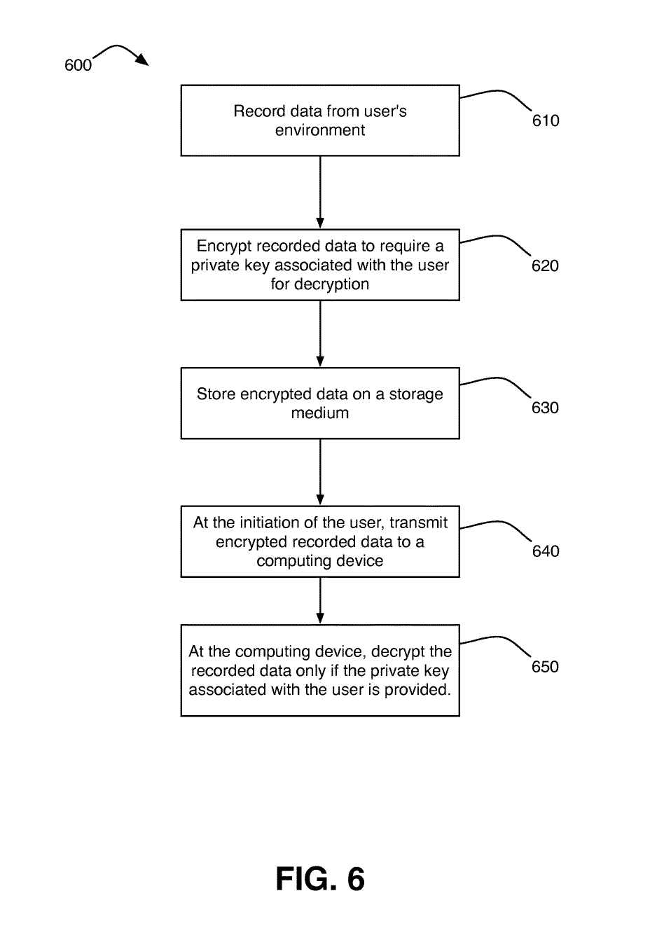

Referring now to FIG. 6, an example of a method 600 in accordance with the present invention is illustrated. Method 600 may be performed using devices such as are described in examples herein, but is not limited to any particular device.

Method 600 may begin with recording step 610. Recording step 610 may record data from the user's environment and/or biometric data describing the user's physiological condition. For example, recording step 610 may record video data, audio data, location data, movement data, heart rate data, galvanic data, and/or other types of data characterizing the user's physiological condition and/or the user's environment.

In encrypting step 620, some or all of the data recorded in recording step 610 may be encrypted using a public key such that the data may only be decrypted using a private key associated with the user. Encrypting step 620 may use any encryption protocol, type, or process. For example, encrypting step 620 may be performed using an encryption component, such as a system on chip processor, to encrypt and/or cryptographically sign the encrypted recorded data using the AES protocol.

In storage step 630 the encrypted recorded data from encryption step 620 may be stored on a storage medium. Storage step 630 may store secure file(s) on a device in accordance with the present invention and/or at another computing device and/or another location. Storage step 630 my use any types of digital storage medium to retain secure file(s) in a non-transitory form that may be decrypted only using the private key associated with the user that was used in encryption step 620.

Transmission step 640 may transfer encrypted recorded data to a computing device. Transmission step 640 may transmit previously stored secure data from storage step 630 and/or may directly transmit encrypted recorded data from encryption step 620. The computing device to which encrypted recorded data is transmitted to in transmission step 640 may be any type of computing device, such as a mobile communication device, a server, a desktop computer, a laptop computer, an appliance, and/or a specially provided computing device. Transmission step 640 may use a cable or other tangible connection medium, but may also use a wireless connection. Further, transmission step 640 may use more than one protocol or communication protocol, such as by exchanging Bluetooth communications with a mobile computing device and then using another standard (such as an 802.11 protocol, LTE, or other wireless communication standard) to transmit data to a wireless router/base station/tower, and may thereafter transmit data over a variety of fiber optics or other media to reach a remote computing device.

Method 600 may conclude with a decrypting step 650. In decrypting step 650 the encrypted data received at the computing device may be decrypted using the private key associated with the user.

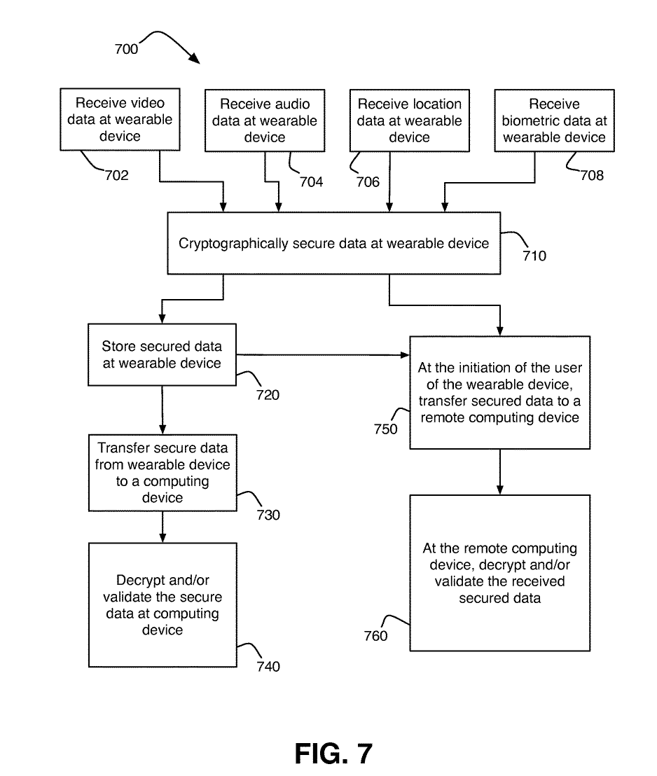

Referring now to FIG. 7, a further example of a method 700 in accordance with the present invention is illustrated. As with the example illustrated in FIG. 6, method 700 may be performed using devices such as described in examples herein, but may use other types of devices as well. While the device used to perform method 700 is described as wearable in the example of FIG. 7, in some examples method 700 may be performed using one or more device that is not wearable but is instead carried by a user and/or mounted upon or integrated with tools or equipment used, carried, or worn but the user.

Data may be received from a user's environment and/or the user in a variety of ways. For example, video data may be received at a wearable device in step 702, audio data may be received at a wearable device in step 704, and/or location data may be received at a wearable device in step 706. Fewer, more, and/or different types of data, such as data describing the climatic conditions around a device, may be received from the user's environment within the scope of the present invention additionally/alternatively. Step 702 may use a digital camera capable of receiving video or still images. Step 704 may use a microphone. Step 706 may use a location services component, such as a GPS system. The camera, microphone, and/or location services component used in steps 702, 704, and 706, respectively, may operate on a device other than the wearable device at which the data is ultimately received. For example, a mobile communication device may receive location data, audio data, and/or video data and provide that data to a wearable device.

Additionally/alternatively to steps 702, 704, 706 that receive data from a user's environment, step 708 may receive biometric data at a wearable device. Step 708 may operate using any kind of biometric sensor, some examples of which are described herein. A sensor that receives biometric data in step 708 may be part of a wearable device but may alternatively/additionally be provided in a device(s) communicatively connected with the wearable device.

In step 710 received data may be cryptographically secured at the wearable device. Cryptographically securing received data may comprise encrypting some or all of the data using a public key such that the data may only be decrypted using a private key associated with the user of the wearable device and/or cryptographically signing some or all of the received data. Step 710 may be performed by any type of processor operating on the wearable device and executing any type of encryption. For example, step 710 may be performed by an SoC encryption component operating using AES.

Method 700 may proceed from step 710 to step 720. Step 720 may store cryptographically secured data at the wearable device. Cryptographically secured data may be stored in any type of storage medium at the wearable device. For example, any sort of volatile and/or non-volatile storage medium may be used. One example of a storage medium that may be used in performing step 720 is flash memory, but other types of storage may be used within the scope of the present invention.

Method 700 may provide a user the opportunity to initiate the transfer of cryptographically secured data to a remote computing device in step 750. Step 750 may transfer data immediately after it is cryptographically secured in step 710 and/or may transfer cryptographically secured data that has been stored in step 720. Step 750 may, for example, permit a user to engage a button or other input to transfer data over a network, such as the Internet, to a server or other computing device. Step 750 may use another computing device, such as a mobile communication device, to access such a network, but a wearable device used to perform method 700 may access such a network directly. Step 750 may transmit the cryptographically secured data through any number and variety of routers, servers, computing devices, and media.

When the cryptographically secured data transferred in step 750 is received at the remote computing device, in step 760 the cryptographically secured data may be decrypted and/or validated at the remote computing device. For example, if the cryptographically secured data was encrypted in step 710, the data may be decrypted only if the private key associated with the user is provided. Similarly, if the cryptographically secured data was signed in step 710, the signature(s) may be validated. Step 760 may occur, for example, at a computing device preselected by a user to receive the encrypted data should step 750 be reached in method 700.

Method 700 need not in all instances proceed from step 710 and/or step 720 to step 750 and then step 760. In some instances, method 700 may proceed from step 720 to transfer cryptographically secured data from the wearable device to a computing device in step 730. Step 730 may involve, for example, connecting the wearable device to the user's computer using a cable, a wireless protocol (such as Bluetooth), etc. Step 730 may be performed periodically to remove secure file(s) from the wearable device to provide additional free storage on the wearable device while still preserving the files. Step 730 may additionally/alternatively be performed to examine the content of the secure file(s).

If the cryptographically secured data transferred to the computing device in step 730 is to be examined, method 700 may proceed to step 740 to decrypt and/or validate the cryptographically secured data. If the secured data was encrypted, step 740 may decrypt the encrypted data only if the private key associated with the user is provided in step 740. Additionally/alternatively, if the cryptographically secured data was signed, the signature(s) may be validated. Step 740 may create a decrypted and/or validate copy of the cryptographically secured data for analysis or viewing, and such decrypted and/or validated data may be transitory or lasting.

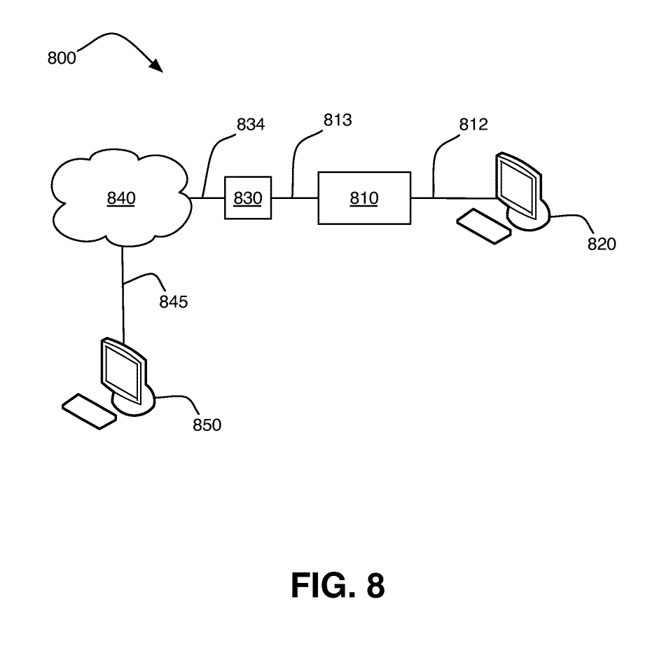

Referring now to FIG. 8, an example of a system 800 in accordance with the present invention is illustrated. A wearable device 810 may optionally (and occasionally) be connected 812 to a computing device 820. Computing device 820 may be used to configure wearable device 810 and/or to receive cryptographically secured data from wearable device 810 over connection 812. Connection 812 may be via a cable or other physical connection, but alternatively/additionally may be wireless. In some examples, wearable device 810 may be removed by a user to connect 812 the wearable device 810 to computer 820.

While in use, wearable device 810 may connect 834 to at least one network 840. Connection 834 may be any wired or wireless connection using any media and/or protocol. Network 840 may comprise the Internet, but may be any public or private network. Network 840 may comprise a plurality of interconnected networks, of which some may be public and some may be private. Wearable device 810 may connect 834 to network 840 via another device, such as a mobile communication device 830 connected 813 to wearable device 810. Connection 813 between wearable device 810 and mobile communication device 830 may be a physical cable, but in many examples connection 813 will utilize a wireless protocol such as Bluetooth.

A remote computing device 850 connected 845 to network 840 may be accessible to wearable device 810. Remote computing device 850 and computing device 820 may be the same device, but need not be. Remote computing device 850 may receive cryptographically secured data from wearable device 810 over network 840 at the initiation of the user of wearable device 810. Remote computing device 850 may validate and/or decrypt cryptographically secured data received from wearable device 810 as described herein.

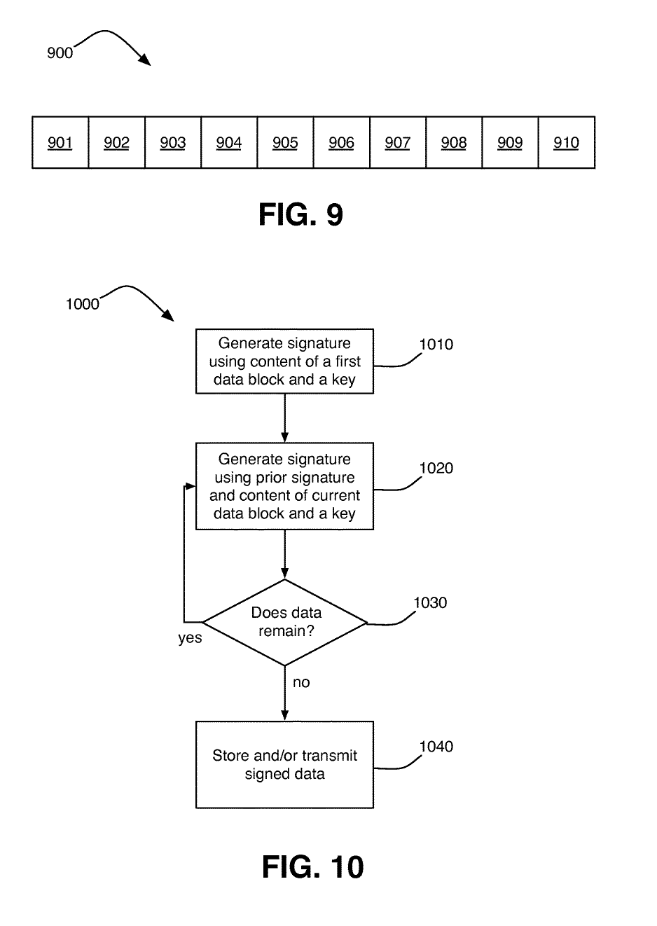

Referring now to FIG. 9, an example of blocks of data 900 that may be cryptographically secured for storage and/or transmission as described herein is illustrated. As can be seen in the example of FIG. 9, data 900 may be received and/or grouped in blocks. Data 900 may comprise a large plurality of blocks, but for the simplicity of illustration in FIG. 9 a first block 901, a second block 902, a third block 903, a fourth block 904, a fifth block 905, a sixth block 906, a seventh block 907, an eighth block 908, a ninth block 909, and a tenth block 910 are illustrated.

Blocks may correspond to frames of video data, but may comprise any grouping of data of any type. For example, audio data, biometric data, location data, and/or any other type of data received by a device and/or method in accordance with the present invention may be blocked or “chunked” to facilitate being cryptographically secured and/or transmitted in accordance with the present invention. While video data may typically comprise frames that may be treated as blocks of data, other types of data may require blocking. For example, MKV files may be used to block data for use in accordance with the present invention. In some examples, one or more block of data may require padding to permit them to be encrypted and/or cryptographically signed.

Potentially each block of data 900 illustrated in the example of FIG. 9 may be encrypted and/or signed and/or transmitted to a remote computing device as described in examples herein. In many instances, however, systems and methods in accordance with the present invention may advantageously cryptographically secure and/or transmit only portions of the data corresponding to particular blocks 901, 902, 903, 904, 905, 906, 907, 908, 909, 910. For example, if cryptographically secured data is to be transmitted to a remote computing device (for example, if a “panic” button has been engaged), network connectivity may be limited. Accordingly, systems and methods in accordance with the present invention may preferentially transmit only every tenth, fiftieth, hundredth, two hundredth, or other block of data. By interleaving blocks of data, at least a portion of the data may be expected to arrive at the destination, and that data may be sufficient to provide a reasonable record of the data 900. For example, should the blocks of data 900 comprise video frames, initially only the first block 901 and the tenth block 910 of the data might be transmitted. In such an example of transmitting every tenth frame of video data, the data received at a remote computing device may comprise poor quality video or even only still photos, but in such a circumstance even poor quality video or still photos may be critical to the user and/or the individual(s) operating the remote computing device. In such an example, intervening blocks of data (such as the fifth block 905) may be transmitted after the first 901 and the tenth 910, with the remaining blocks of data (902, 903, 904, 906, 907, 908, 909) transmitted subsequently. In many examples of systems and methods in accordance with the present invention, video recording may occur at a frame rate such that rather than initially transferring every tenth frame (as described in the example above) every hundredth frame may be transferred, but the principle illustrated remains. Interleaved blocks of data may be transferred to a remote computing device, and then blocks of data received at the remote computing device may then be assembled as fully as possible to provide information regarding the environment and/or physiological state of the user.

Blocks of data 900 may additionally/alternatively be used to encrypt and/or cryptographically sign the data 900. For example, some or all blocks 901, 902, 903, 904, 905, 906, 907, 908, 909, 910 may be signed using a blockchain operation that uses the content of a prior block(s) to validate the content of that given block of data. For example, a signature placed on the first block 901 may be generated using a cryptographic key and a hash value generated using the content of the first block 901, while the signature placed on the second block 902 may be generated using the cryptographic key and a hash value generated using the contents of the second block and the hash value of the first block, and so on until all blocks of data 900 have been signed. In such a fashion, the modification and/or removal of any block of data will invalidate the signature on that block of data and/or each subsequent block of data. Of course, in some examples, such as but not limited to some relatively high frame rates of video data, not ever block of data need be cryptographically signed in this fashion, as signing every tenth, twentieth, or other block of data (depending upon the frame rate) may be sufficient to validate the data. In many examples, every twentieth or thirtieth frame of video data may be signed, but dependent upon the frame rate and the desires of a user different signing frequencies may be used. For example, if video is recorded at a rate of 10 to 15 frames per second every third or fourth frame may be signed.

Various aspect of the frequency of blocks signed and/or transmitted may be selected by a user in some examples. For example, the frequency of signatures may be a user selectable option, with more frequent signatures being more secure but more computationally demanding. Similarly, the number of blocks of data obtained may be user selectable in some examples, such as when the blocks of data are video frames and the user may select a frame rate for recording. While the signing and interleaved transmission of blocks of data have been described separately above, in many examples the first blocks of data transferred in an interleaved transmission may be the blocks of data that were signed. In such an example, the signed blocks of data may be validated at the remote computing device with unsigned data being used to fill gaps between the signed blocks if and when those unsigned blocks are received.

An example of a method 1000 for cryptographically signing data in accordance with the present invention is illustrated in FIG. 10. In step 1010 a block of data may be signed using the content of a first block of data and a cryptographic key. While the present invention is not limited to any encryption standard or protocol, the SHA-2 family of hash functions (such as SHA-256, SHA-512, SHA-224, SHA-384, SHA-512/224, and SHA-512/256) may be used. In step 1020 a subsequent block of data may be signed using a prior signature (such as the one generated in step 1010 or a prior iteration of step 1020) and the content of the block of data to be signed to generate a signature. Step 1030 may determine whether data remains to be signed. If the result of step 1030 is to conclude that data remains to be signed, method 1000 may return to step 1020 to iteratively sign the next block of data. If the outcome of step 1030 is that no data remains to be signed, method 1000 may proceed to step 1040 to store and/or transmit the signed data. The signature(s) on block(s) of data may later be used to validate the data.

While the description and figures herein illustrate some examples of systems and methods in accordance with the present invention, the present invention is not limited to the examples described herein.

Systems in accordance with the present invention may distribute functionality among more than one device and, and devices used in accordance with the present invention may take a variety of forms beyond those described herein. Within a device in accordance with the present invention, the functionality described herein may be distributed differently than has been described. For example, a single processor may perform all of the functionality described, but a plurality of specialty processors (encryption processors, audio processors, video processors, other digital signal processors, communication processors, etc.) may be used within the scope of the present invention. No particular type or architecture of a processor is required in accordance with the present invention. For example, a system on a chip (SoC) and/or an accelerator on a chip may be used to perform some or all of the functions described herein, but other processors may be used instead of or in addition to those examples.

The digital storage medium described in accordance with the examples herein may also be varied without departing from the scope of the present invention. Instructions embodied to cause the processor(s) of a device in accordance with the present invention to perform methods as described herein may be retained in a machine-readable format and in a non-transitory form on the same or a different digital storage medium than is used to store data recorded in accordance with the present invention. Storage for data may be distributed at different locations or digital storage media on a device in accordance with the present invention, may be distributed between digital storage media on a device in accordance with the present invention and another device, or entirely provided using another device. For example, if a device in accordance with the present invention is powered by a sufficiently robust power source (such as, for example, when the device is coupled to an automobile), transferring data to another device (through any kind of media/protocol) may provide more extensive storage than could be obtained on the device itself and the availability of an ample power supply would obviate concerns about powering a device for the transfer of data to the storage device.

The present invention is not limited to any particular encryption methodology, storage medium, network or communication protocol, processor type, battery type or configuration, recording device(s), etc.

1. A system for cryptographically recording the environment of a user, the system comprising:
at least one camera that receives video input;
at least one microphone that receives audio input;
at least one processor that produces video data and audio data from the video input and the audio input;
an encryption system that cryptographically secures the video data and the audio data, wherein cryptographically securing the video data and the audio data comprises at least one of cryptographically signing using a blockchain function and encrypting to prevent access without a private key associated with the user of the device;
at least one digital storage medium that retains the cryptographically secured video data and the cryptographically secured audio data; and
at least one communication interface operably connected to the at least one digital storage medium to permit the cryptographically secured video data and the cryptographically secured audio data to be transferred from the at least one digital storage medium to a computing device without compromising the cryptographically secured video data and the cryptographically secured audio data.

2. The system of claim 1, further comprising at least one biometric sensor that measures at least one physiological property of the user to produce biometric data, and wherein the biometric data measured by the at least one biometric sensor is cryptographically secured by the encryption system, retained by the digital storage medium, and transferred to the computing device by the at least one communication interface without compromising the cryptographically secured biometric data.

3. The system of claim 2, further comprising a location services component that measures the location of the system to produce location data, and wherein the location data is cryptographically secured by the encryption system, retained by the digital storage medium, and transferred to the computing device by the at least one communication interface without compromising the cryptographically secured biometric data.

4. The system of claim 2, further comprising a housing that physically contains at least the at least one camera, the at least one microphone, the at least one biometric sensor, the at least one digital storage medium, the at least one encryption system, and the at least one communication interface.

5. The system of claim 4, further comprising a plurality of batteries powering the at least one camera, the at least one microphone, the at least one biometric sensor, and the at least one encryption system, and wherein at least one of the plurality of batteries is not physically contained by the housing.

6. The system of claim 5, wherein the plurality of batteries flexibly join the housing, and wherein the batteries secure the housing to a wrist of the user.

7. The system of claim 6, wherein the batteries comprise at least one of a plurality of lithium polymer batteries and a plurality of think film lithium ion batteries.

8. The system of claim 4, further comprising:
at least one wireless communication interface that communicates with a remote computing device over at least one network; and
at least one user engageable input that, upon engagement, initiates the transfer of at least some cryptographically secured data from the device to the remote computing device.

9. The system of claim 8, wherein the remote computing device is a server accessed over the Internet.

10. The system of claim 9, wherein the at least some cryptographically secured data transferred to the remote computing device comprises interleaved blocks of data.

11. The system of claim 10, wherein the video data transferred to the remote computing device comprises frames of video data and wherein the interleaved data comprises frames of video data.

12. The system of claim 11, wherein only a subset of frames of video data are cryptographically signed and interleaving comprises first transferring the cryptographically signed frames of video data.

13. A method for recording the environment of a user, the method comprising:
recording video, audio, and biometrics describing the physiology of the user using a device worn by the user to produce video data, audio data, and biometric data;
cryptographically securing at least some of the video data, the audio data, and the biometric data with an encryption system contained within the device worn by the user, cryptographically securing comprising at least one of cryptographically signing using a blockchain function and to require a private key associated with the user to decrypt the data;
storing the cryptographically secured video data, audio data, and biometric data on at least one digital storage medium contained within the device worn by the user;
transferring the cryptographically secured video data, audio data, and biometric data to a second computing device; and
at the second computing device, validating the cryptographic signature if the cryptographically secured video data, audio data, and biometric data was signed using a blockchain function and decrypting the video data, audio data, and biometric data using a private key associated with the user if the cryptographically secured video data, audio data, and biometric data was encrypted.

14. The method of claim 13, wherein cryptographically securing at least some of the video data, audio data, and biometric data comprises both cryptographically signing and encrypting the video data, audio data, and biometric data.

15. The method of claim 13, wherein transferring the cryptographically secured video data, audio data, and biometric data to a second computing device comprises transferring data through a wired connection between the device worn by the user and the second computing device.

16. The method of claim 13, wherein transferring the cryptographically secured video data, audio data, and biometric data to a second computing device comprises wirelessly transferring the data to a mobile communication device.

17. The method of claim 13, wherein transferring the cryptographically secured video data, audio data, and biometric data to a second computing device comprises transferring the data to a computing device over the Internet.

18. A device for recording the environment of a user, the device comprising:
a housing wearable by the user;
a camera within the housing, the camera receiving visual information from outside the housing;
a microphone within the housing, the microphone receiving audio information from outside the housing;
a biometric sensor within the housing, the biometric sensor measuring a physiological property of the user wearing the housing;
an encryption system within the housing that cryptographically secures data received from the camera, microphone, and the biometric sensor, the encryption system performing at least one of cryptographically signing the data using a blockchain function and encrypting the data such that a private key associated with the user is required to decrypt the data;
at least one digital storage medium within the housing that retains the cryptographically secured data;
at least one communication interface within the housing permitting the cryptographically secured data to be transferred from the at least one digital storage medium to a second computing device; and
a plurality of batteries integrated into bracelet links to retain the housing on the wrist of the user and to power the camera, the microphone, the biometric sensor, and the encryption system.

19. The device of claim 18, wherein the at least one communication interface comprises a wireless communication interface that connects the device to a mobile communication device, and wherein the mobile communication device provides location service information to the encryption system and the encryption system cryptographically secures the location information.

20. The device of claim 18, wherein the plurality of batteries comprise at least one of a plurality of lithium polymer batteries and a plurality of thin film lithium ion batteries.
